(19) United States
(12) Patent Application Publication
(10) Pub. No.: US 2018/0018784 A1
(43) Pub. Date: Jan. 18, 2018

(54) Systems and Methods for Parcel Tracking and Delivery

(71) Applicant: Carlos E. Cano, Austin, TX (US)

(72) Inventor: Carlos E. Cano, Austin, TX (US)

(21) Appl. No.: 15/627,956

(22) Filed: Jun. 20, 2017

Related U.S. Application Data
(60) Provisional application No. 62/363,644, filed on Jul. 18, 2016.

(51) Int. Cl. G06F 17/30; G06Q 10/08

(52) U.S. Cl. CPC G06T 7/337; G06F 17/30247; G06Q 10/0833

(57) ABSTRACT

The recipient address on the parcel is any image displayed on the exterior surface. The image is associated with a recipient address in a database. The image is read with an image reading device. An App recognizes the image and determines the associated recipient address. Tracking of the parcel from the sender to the recipient is displayed by the App on the image reading device.

### CROSS-REFERENCE TO RELATED APPLICATIONS

The present application is related to, is a continuation-in-part of, claims priority from and benefit of U.S. provisional patent application Ser. No. 62/363,644, filed Jul. 18, 2016, entitled Methods And Systems For Package Delivery Tracking, by the same inventor, the disclosure of which is incorporated herein by reference.

### TECHNICAL FIELD

The present invention relates to package delivery and particularly to systems and methods for addressing, delivery and tracking of a package.

### SUMMARY

The delivery of a package typically requires a delivery mailing address to be legibly displayed on the package. Tracking of the package shipping progress is premised on arrival of the package at the delivery address. There are disadvantages to relying on a standard delivery address, however. Most common, perhaps, is the use of address labels, special envelops or packaging, bar codes and so forth. The present invention eliminates the need for any such addressing conventions or requirements. Another concern is misdelivery to the wrong address. Misdelivery may particularly be a problem in multi-tenant destinations where apartment, suite, or unit designations get mixed up.

The present invention provides systems and methods that eliminate all requirements related to labels, packaging or bar codes. The invention simplifies addressing for letter, packages and parcels. Additionally, the present invention reduces the frequency of package misdelivery by eliminating the use of a standard address on the parcel, because a written address can be incorrect, illegible or misread by the carrier. The invention also simplifies the identification of any package in any other logistic environment. The present invention employs a user-generated graphic that is linked to the delivery address in the system of the invention. A tracking image, such as for example an alpha numeric code or a graphic design is linked to both the sender and the recipient address. In an specific exemplary embodiments the tracking image is generated by the sender and displayed on the exterior surface of the package by the sender, although in specific alternative exemplary embodiments the tracking image is provided by the delivery service and is delivered by electronic means to the sender for displayed on the package by the sender. The present systems and methods operate independent of package size or package form.

Sender can create tracking images on his/her own and display the tracking image on the exterior surface of the parcel by any suitable means, such as, for example, by drawing the tracking by hand, or, in cases where the tracking is created electronically, printing the image on an adhesive label or sticker and applying the label bearing the image to the exterior surface of the parcel, or also in the alternative by having the tracking image printed directly on the exterior surface of the parcel or on the parcel wrapping.

In the exemplary embodiments where the tracking image is provided by the delivery service and delivered to the sender for use on the parcel, the delivered tracking image is applied on the exterior surface of the parcel by the sender by any of the means described above or by any other suitable means, to display the image.

The tracking image is then captured by a device and recognized by the system or application enabling the courier company to link the tracking image to the origin and destination or delivery address to transport the package to the destination.

An exemplary embodiment of the present method entails providing a parcel delivery App capable of accessing a database of recipient addresses and that is operable on the smart phone or other suitable device, installing the parcel delivery App on a device, such as for example a smart phone, portable scanner, computer, or other suitable device, generating one or more tracking images, assigning the one or more tracking images to a recipient address in the database displaying one of the one or more tracking images anywhere on the external surface of the parcel, photographing or otherwise detecting the tracking image with the device, using the App installed on the device to recognize the tracking image and to associate the image with a recipient address assigned to the tracking image, and delivering the parcel to the address assigned to the tracking image. In specific alternative exemplary embodiments, the App also calculates and displays the delivery charge amount to the sender. In still other exemplary alternative embodiments, the App obtains the delivery charge amount from the sender.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 is a method steps flow chart of a method of the present invention.

### DETAILED DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In the following discussion and in the claims, the terms “including” and “comprising” are used in an open-ended fashion, and thus should be interpreted to mean “including, but not limited to . . . .” Also, the term “connect” or “connected” where used if at all is intended to mean either an indirect or direct connection. Thus, if a first component connects to a second component, that connection may be through a direct connection or through an indirect connection via other components and connections.

Certain terms are used throughout the following description and claims to refer to particular system components and method steps. As one skilled in the art will appreciate, different companies may refer to a component by different names. This document does not intend to distinguish between components that differ in name but not function.

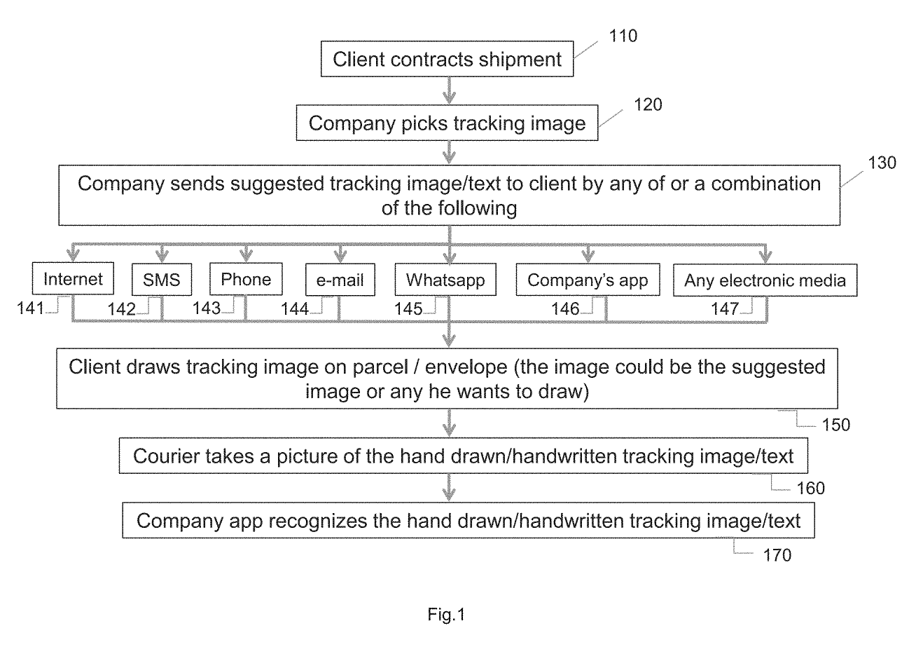

FIG. 1 is a method steps flow chart of a method of the present invention. Although the invention is described in relation to specific exemplary embodiments of packages and envelopes, it will be understood than any object, even if not in a container, can be addressed and delivered by the present systems and methods. Additionally, although the invention is described in relation to the specific exemplary embodiment of package delivery, it will be understood that the systems and methods may find application in any environment where logistics are managed, including production or manufacturing logistics, inventory control, geolocation of objects, and the like.

To deliver the parcel of FIG. 1, including an envelope, to a destination, a client contracts with a business for shipment 210. The business selects one or more suggested tracking images 220. The business sends the suggested tracking images to the client via one or more communication technologies 230 such as the Internet 241, SMS, 242, smart phone 243, email 244, Whatsapp® 245, an App proprietary to the shipping business 246, or any other suitable electronic communication means 247.

Continuing with FIG. 1, the client creates a tracking image and displays the tracking image on the parcel in any area of the address portion of an exterior surface of the parcel or envelope 250. The client may use one of the one or more of the tracking images suggested by the shipping business or the client may create his or her own tracking image. The tracking image may be created by a hand drawing, digital image creation means, or any other suitable means to create an image. The tracking image may be created directly on the exterior surface of the parcel or envelope, or the tracking image may be rendered on a label or other intermediary surface that is capable of being affixed to the exterior surface of the parcel or envelope. The tracking image maybe a graphic image, an alphanumeric image such as a number or letter string or combination of letters and numbers, or any other suitable image.

A courier for the shipping business takes a photograph of the tracking image with a smart phone camera 260. An App installed on the courier's smart phone recognizes the image 270 and associates the image with a recipient address in a database accessible by the App.

In specific exemplary embodiments, the invention further provides the steps of tracking the progress of parcel delivery from the sender to the recipient and displaying the tracking information in the App. Additionally, the present invention delivers tracking images or text by electronic means so the sender can use any writing tool to draw or write it on the parcel and be recognized by the system through the use of any cellphone with camera or any other camera holding apparatus.

The present invention provides the delivery of tracking images by electronic means and an App that recognizes those tracking images drawn by hand on any parcel. The present invention eliminates the use of forms containing the tracking numbers or barcodes, eliminates the need of materials in order to attach the forms containing the tracking numbers or barcodes on parcels, eliminates the need to transport the forms containing the tracking numbers or barcodes to the sender's location, and eliminates the need to bring the parcel to a shipping location to attach the forms containing the tracking number or barcode.

The present invention reduces paper use, reduces gasoline use, and reduces general maintenance on shipping transport units. An interesting feature of the present invention is that it delivers tracking images or text by any electronic means so the sender can use any writing tool to draw or write the tracking image on the parcel and it will be recognized by the system through the use of any suitable device with a camera or any other camera holding apparatus or any other image reading device such as a scanner and the like.

The present invention provides a method for logistics in a logistics environment. The method includes the steps of:
providing an object to be identified and tracked;
identifying the object with a marking;
associating the marking with a corresponding database entry; and
locating the object at any point in the logistics environment.

In addition to the foregoing embodiments, the present disclosure provides programs stored on non-transient machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

Many modifications and other embodiments of the invention described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for addressing, identifying and delivering a parcel, the method comprising the steps of:
providing a parcel delivery App capable of accessing a database of recipient addresses and that is operable on a device;
installing the parcel delivery App on the device;
generating one or more tracking images;
assigning the one or more tracking images to a recipient address in the database;
displaying one of the one or more tracking images on an external surface of the parcel;
photographing the tracking image with the device;
using the App installed on the device to recognize the tracking image and to associate the image with a recipient address assigned to the tracking image;
and
delivering the parcel to the address assigned to the tracking image.

2. The method of claim 1, further comprising the step of tracking delivery of the parcel.

3. The method of claim 1, wherein the step of generating the one or more tracking images comprises creation of one or more tracking images by a user of the method.

4. The method of claim 1, wherein the step of generating the one or more tracking images comprises selecting one or more tracking images suggested by the parcel delivery service.

5. The method of claim 4, further comprising the steps of the parcel delivery service transmitting the one or more selected tracking images to a client; and the client displaying on the parcel one of the one or more tracking images assigned to the recipient address.

6. The method of claim 5, wherein the one or more selected tracking images is transmitted electronically by one ore more means selected from the following: Internet, SMS, smart phone, email, Whatsapp®, an App proprietary to the parcel delivery service.

7. The method of claim 1, wherein the tracking image comprises a graphic design.

8. The method of claim 1, wherein the tracking image comprises alphanumeric markings.

9. The method of claim 1, wherein the tracking image comprises a combination of graphic design and alphanumeric markings.

10. A method for logistics in a logistics environment, the method comprising the steps of:
providing an object to be identified and tracked;
identifying the object with a marking;
associating the marking with a corresponding database entry; and
locating the object at any point in the logistics environment.

11. A system for addressing a parcel and delivering the parcel, the system comprising:
one or more image reading devices;
one or more Apps installed on one or more of the one or more image reading devices, at least one of the one or more Apps being capable of recognizing a tracking image and associating the tracking image with a recipient address in a database that can be accessed by the tracking image recognition App; and
a database of recipient addresses that can be accessed by the tracking image recognition App.

12. The system of claim 11, wherein at least one of the one or more Apps provides a delivery tracking display to monitor the progress of the parcel from sender to recipient.
